(19) United States
(12) Patent Application Publication
(10) Pub. No.: US 2021/0011490 A1
(43) Pub. Date: Jan. 14, 2021

(54) FLIGHT CONTROL METHOD, DEVICE, AND MACHINE-READABLE STORAGE MEDIUM

(71) Applicant: SZ DJI TECHNOLOGY CO., LTD., Shenzhen (CN)

(72) Inventors: Jie QIAN, Shenzhen (CN); Qifeng WU, Shenzhen (CN); Hongda WANG, Shenzhen (CN)

(21) Appl. No.: 16/934,948

(22) Filed: Jul. 21, 2020

Related U.S. Application Data
(63) Continuation of application No. PCT/CN2018/073870, filed on Jan. 23, 2018.

(51) Int. Cl. G05D 1/10; G06T 7/55; G06T 7/70; G06T 7/62; B64D 47/08; G08G 5/00; G05D 1/04

(52) U.S. Cl. CPC G05D 1/101; G06T 7/55; G06T 7/70; G06T 7/62; B64D 47/08; B64C 39/024; G05D 1/042; G08G 5/0047; G06T 2207/10028; G06T 2207/30252; G08G 5/003

(57) ABSTRACT

A flight control method includes determining a distance of a target relative to an aircraft based on a depth map acquired by an imaging device carried by the aircraft, determining an orientation of the target relative to the aircraft, and controlling flight of the aircraft based on the distance and the orientation.

### CROSS-REFERENCE TO RELATED APPLICATION

This application is a continuation of International Application No. PCT/CN2018/073870, filed Jan. 23, 2018, the entire content of which is incorporated herein by reference.

### TECHNICAL FIELD

The present disclosure relates to image processing technologies, and in particular, to a flight control method, a device and a machine-readable storage medium.

### BACKGROUND

The main control method of an aircraft has been done through a remote control and sticks of the remote control are used to control the aircraft to go forward, backward, left, right, up and down, or rotate. There are many limitations of controlling the flight of the aircraft through the remote control. For example, the remote control has to be carried around, and problems with the remote control will make the aircraft unusable.

Therefore, how to get rid of the dependence of the aircraft on the remote control, and let the aircraft respond to the motion of the specified target, such as movement, gestures, etc., and perform the corresponding flight motion has become a popular research direction in the field of aircraft flight control.

### SUMMARY

In accordance with the disclosure, there is provided a flight control method including determining a distance of a target relative to an aircraft based on a depth map acquired by an imaging device carried by the aircraft, determining an orientation of the target relative to the aircraft, and controlling flight of the aircraft based on the distance and the orientation.

Also in accordance with the disclosure, there is provided a flight control device including a processor and a memory. The processor is configured to determine a distance of a target relative to an aircraft based on a depth map acquired by an imaging device carried by the aircraft, determine an orientation of the target relative to the aircraft, and control flight of the aircraft based on the distance and the orientation. The memory is configured to store the distance and the orientation.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a flowchart of a flight control method according to an embodiment of the disclosure.

FIG. 2 is a flowchart of a flight control method according to another embodiment of the disclosure.

FIG. 3 is a flowchart of a flight control method according to another embodiment of the disclosure.

FIG. 4 is a structural diagram of a flight control device according to an embodiment of the disclosure.

FIG. 5 is a structural diagram of an aircraft according to an embodiment of the disclosure.

### DETAILED DESCRIPTION OF THE EMBODIMENTS

The technical solutions in the example embodiments of the present disclosure will be described clearly with reference to the accompanying drawings. The described embodiments are some of the embodiments of the present disclosure, rather than all the embodiments. Based on the embodiments of the present disclosure, all other embodiments obtained by a person of ordinary skill in the art without creative efforts shall fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The embodiments of the present disclosure are described as follows in detail with reference to the accompanying drawings. In the case of no conflict, the following embodiments and the features in the embodiments can be combined with each other.

A flight control method is provided according to an embodiment of the present disclosure. FIG. 1 is a schematic flowchart of the flight control method according to an embodiment of the present disclosure. This method can be applied to an aircraft, such as an unmanned aerial vehicle (UAV), and the aircraft is provided with a first imaging device. In some embodiments, the first imaging device includes but is not limited to an imaging device that can obtain a depth map, such as a binocular camera or a time of flight (TOF) camera, and the first imaging device may be fixed at the aircraft.

As shown in FIG. 1, at 101, a first distance of a target relative to the aircraft is determined based on a depth map acquired by the first imaging device.

In applications, in order to determine the distance between the target and the aircraft (hereinafter referred to as the first distance) based on the depth map acquired by the first imaging device (hereinafter simply referred to as the depth map), the target may be determined in the depth map first, then the first distance of the target relative to the aircraft is determined based on the depth map.

In an embodiment, after the depth map is obtained through the first imaging device, clustering analysis can be performed on the depth map to cluster different pixels of the depth map into different point clouds, and then the target can be recognized based on the shape and/or size of the point clouds obtained from clustering.

In another embodiment, a second imaging device may also be provided at the aircraft, and the second imaging device includes but is not limited to a digital camera, a digital video camera, or the like. The second imaging device can be fixedly connected to a gimbal arranged at the aircraft, can move with the movement of the gimbal, and shot images of the second imaging device (i.e., images shot by the second imaging device) can be transmitted to a designated terminal device in real time, such as a mobile terminal of an aircraft user.

In some embodiments, in order to determine the target in the depth map, a visual frame in which the target is framed may be determined in the shot image from the second imaging device.

In one embodiment, in an aircraft-follow-target mode, the user may specify the target in the shot image displayed on the above-mentioned specified terminal device, and further, a visual frame corresponding to the target is generated.

In another embodiment, in the aircraft-follow-target mode, all the targets and the types of the targets can be identified in the shot image from the second imaging device by way of image recognition. When there is only one target to select in the shot image from the second imaging device, the only target can be directly determined as a target to follow and a visual frame corresponding to the target can be generated. When there are multiple targets to select in the shot image from the second imaging device, the target to follow can be determined according to a preset strategy, and a visual frame corresponding to the target can be generated. For example, among the targets to select, the front target can be determined as the target to follow, or the middle target can be determined as the target to follow, or, the backmost target can be determined as the target to follow, etc.

In some embodiments, after the visual frame corresponding to the target is determined in the shot image from the second imaging device, the visual frame may be rotationally mapped to the depth map, and then the target in the depth map may be determined based on the visual frame mapped to the depth map.

For example, among the point clouds obtained by clustering pixel points in the depth map, a point cloud having the largest overlapping area with the visual frame mapped to the depth map may be determined as the target.

At 102, a first orientation of the target relative to the aircraft is determined.

In applications, in order to determine the positional relationship between the aircraft and the target, in addition to determining the distance between the target and the aircraft, the orientation of the target relative to the aircraft may also need to be determined.

In an embodiment, each pixel of the depth map may be clustered, the target may be identified based on the shape and/or size of the point cloud obtained by the clustering, and the position of the target in the depth map may be determined, and further, the orientation of the target relative to the aircraft (referred to herein as the first orientation) may be determined based on the position of the target in the depth map.

In another embodiment, the visual frame with the target in the shot image from the second imaging device may be determined according to the method described in the process of 101, and then, the first orientation of the target relative to the aircraft may be determined based on the position of the visual frame in the shot image.

For example, the angle between two adjacent pixels can be determined according to the field of view (FOV) of the second imaging device and the resolution of the shot image from the second imaging device, and then, based on the pixel coordinate of the center of the visual frame in the shot image, the pixel offset value between the center of the visual frame and the center of the shot image can be determined, and further, the deviation angle of the target relative to the optical axis of the second imaging device can be obtained. Since the second imaging device is fixedly connected to the gimbal, the attitude angle of the gimbal is the attitude angle of the optical axis of the second imaging device, and the first orientation of the target relative to the aircraft can be the sum of the attitude angle of the gimbal and the deviation angle of the target relative to the optical axis of the second imaging device.

In another embodiment, the target may be determined in the grayscale image acquired by the first imaging device, and the first orientation of the target relative to the aircraft may be determined based on the position of the target in the grayscale image.

In an example, in order to determine the target in the grayscale image acquired by the first imaging device, the visual frame with the target in the shot image from the second imaging device may be determined according to the method described in the process of 101, and the visual frame is rotationally mapped to the grayscale image, and further, the target is determined in the grayscale image based on the visual frame mapped to the grayscale image.

In another example, in order to determine the target in the grayscale image acquired by the first imaging device, the target can be directly identified in the grayscale image using image recognition method.

At 103, the flight of the aircraft is controlled based on the first distance and the first orientation.

In applications, after determining the first distance and the first orientation of the target relative to the aircraft, the flight of the aircraft may be controlled based on the first distance and the first orientation.

In one embodiment, in the aircraft-follow-target mode, the first distance and the first orientation can be used to control the aircraft to follow the target.

In another embodiment, in a mode of controlling the aircraft based on the gesture of the target, the aircraft may be controlled in response to the gesture control instruction of the target based on the first distance and the first orientation.

It can be seen from the above processes of 101 to 103 that, in the present disclosure, the distance between the target and the aircraft is determined based on the depth map acquired by the first imaging device, and the orientation of the target relative to the aircraft is determined, and further, the distance and orientation of the target relative to the aircraft can be used to control the flight of the aircraft. Therefore, it is realized that the flight of the aircraft can be controlled without the need of a remote control, which improves the efficiency of flight control. Determining the distance of the target relative to the aircraft through the depth map can improve the accuracy of determining the distance of the target relative to the aircraft, as a result, the accuracy of the flight control of the aircraft is improved.

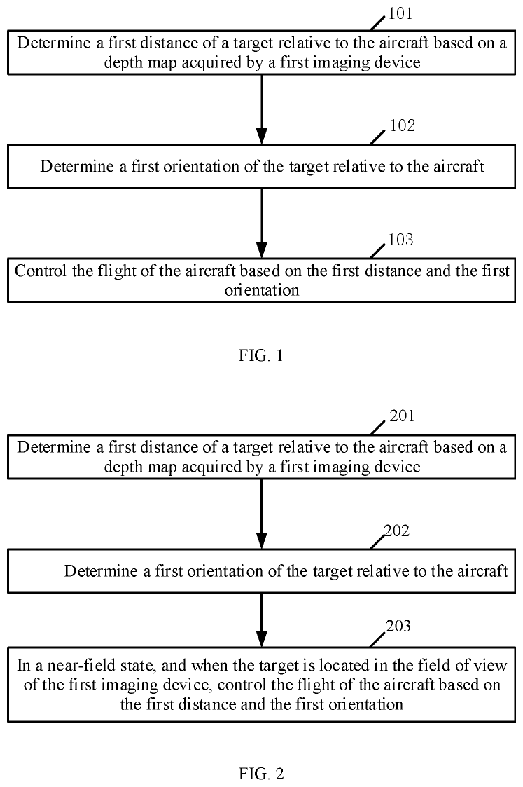

FIG. 2 is a schematic flowchart of a flight control method according to another embodiment of the present disclosure. As shown in FIG. 2, at 201, a first distance of a target relative to an aircraft is determined based on a depth map acquired by a first imaging device.

The process of 201 is similar to the process of 101 and is not described again.

At 202, a first orientation of the target relative to the aircraft is determined.

The process of 202 is similar to the process of 102 and is not described again.

At 203, in a near-field state, when the target is located in the field of view of the first imaging device, the flight of the aircraft is controlled based on the first distance and the first orientation.

The process of 203 can be a special example of the process of 103.

In some embodiments, when the proportion of the size of a visual frame of the target in a shot image is greater than or equal to a preset first ratio threshold, and/or a distance between the target and the aircraft is less than or equal to a preset first distance, it is determined to be in the near-field state.

In some embodiments, at 203, in the near-field state, the accuracy of determining the first distance using the visual frame is poor. However, a better effect can be achieved with the depth map in the near-field state, and the accuracy of determining the distance between the target and the aircraft based on the depth map is higher.

Correspondingly, in some embodiments, in the near-field state, when the target is located in the field of view of the first imaging device, the flight of the aircraft may be controlled based on the first distance and the first orientation.

In an embodiment, in the near-field state, when the target disappears from the field of view of the first imaging device, the current orientation of the target relative to the aircraft may be determined based on the visual frame, and further, according to a first coordinate of the target in a navigation coordinate system of the last determination and the current orientation, the first coordinate of the target in the navigation coordinate system can be updated.

The first coordinate of the target in the navigation coordinate system is the coordinate of the target in the navigation coordinate system determined based on the first distance and the first orientation, and the specific determination method is described below.

In some embodiments, in the near-field state, when the target disappears from the field of view of the first imaging device, the coordinate of the target in the navigation coordinate system need to be maintained by using the orientation of the target relative to the aircraft determined by using the visual frame.

Specifically, when the target disappears from the field of view of the first imaging device, and the target exists within the field of view of a second imaging device, the orientation of the target relative to the aircraft may be determined by using the method of the visual frame according to the process of 102. That is, a visual frame with the target in the shot image from the second imaging device is determined, and the orientation of the target relative to the aircraft is determined based on the position of the visual frame in the shot image.

After the current orientation of the target relative to the aircraft is determined, according to the first coordinate of the target in the navigation coordinate system of the last determination and the current orientation, the first coordinate of the target in the navigation coordinate system can be updated.

For example, assuming that the first coordinate determined last time before the target disappears from the field of view of the first imaging device is (Xe1, Ye1) and the current orientation of the target relative to the aircraft determined by the visual frame is Yaw_{target}2drone2, the first coordinate (Xe2, Ye2) after the first update is:

Xe2=X_{d}1+cos(Yaw_{target2drone}2)*dₚᵣₑ 1

Ye2=Y_{d}1+sin(Yaw_{target2drone}2)*dₚᵣₑ 1

where (X_{d}1, Y_{d}1) denotes the coordinate of the aircraft in the navigation coordinate system when the target is at the determined first coordinate (Xe1, Ye1), and can be obtained by fusing data from a global positioning system (GPS) and a visual odometry (VO). dₚᵣₑ1 is the distance between the target and the aircraft at the last determination before the target disappears from the field of view of the first imaging device, that is, the distance between (Xe1, Ye1) and (X_{d}1, Y_{d}1) in the navigation coordinate system.

In some embodiments, after the first coordinate is updated according to the above method, the distance between the target and the aircraft may be updated according to the updated first coordinate and the latest coordinate of the aircraft in the navigation coordinate system, and according to the updated distance and the latest current orientation of the target relative to the aircraft determined using the visual frame method, the first coordinate is updated again.

For example, assume that the updated first coordinate is (Xe2, Ye2), and the latest coordinate of the aircraft in the navigation coordinate system is (X_{d}2, Y_{d}2), then the updated distance dₚᵣₑ2 between the target and the aircraft is the distance between (Xe2, Ye2) and (X_{d}2, Y2) in the navigation coordinate system. If the latest current orientation of the target relative to the aircraft determined by the visual frame method at this time is Yaw_{target2drone}3, the further updated first coordinate (Xe3, Ye3) is

Xe3=X_{d}2+cos(Yaw_{target2drone}3)*dₚᵣₑ2

Ye3=Y_{d}2+sin(Yaw_{target2drone}3)*dₚᵣₑ2

According to the above method, in the near-field state, before the target returns to the field of view of the first imaging device again, the first coordinate of the target in the navigation coordinate system may be updated all the time.

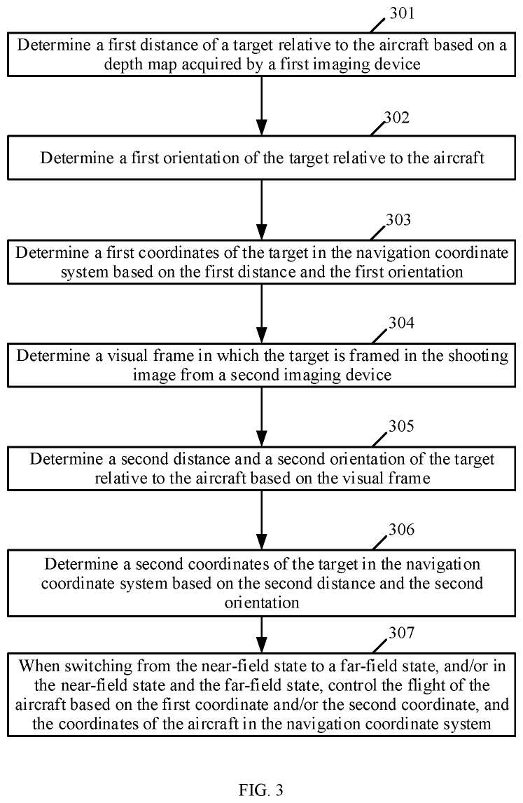

FIG. 3 is a schematic flowchart of a flight control method according to another embodiment of the present disclosure. As shown in FIG. 3, at 301, a first distance of a target relative to an aircraft is determined based on a depth map acquired by a first imaging device.

The process of 301 is similar to the process of 101 and is not described again.

At 302, a first orientation of the target relative to the aircraft is determined.

The process of 302 is similar to the process of 102 and is not described again.

At 303, a first coordinate of the target in a navigation coordinate system is determined based on the first distance and the first orientation.

In applications, after the first distance and the first orientation are determined, the coordinate of the target in the navigation coordinate system (referred to as the first coordinate in the disclosure) (Xt1, Yt1) can be determined according to the following formula:

Xt1=X_{d}+cos(Yaw_{target2drone}1)*d1

Yt1=Y_{d}+sin(Yaw_{target2drone}1)*d1

where (X_{d}, Y_{d}) represents the coordinate of the aircraft in the navigation coordinate system, which can be obtained by fusing data from a GPS and a VO, Yaw_{target2drone}1 is the first orientation, and d1 is the first distance.

At 304, a visual frame with a target in a shot image from the second imaging device is determined.

In applications, for the specific implementation of determining the visual frame with the target in the shot image from the second imaging device, reference may be made to the relevant description in the process of 101, which is not repeated here.

At 305, a second distance and a second orientation of the target relative to the aircraft are determined based on the visual frame.

In applications, for the specific implementation of determining the distance between the target and the aircraft (referred to as the second distance herein) based on the visual frame, reference may be made to the related description in the existing related solution, which is not repeated here.

For the specific implementation of determining the orientation of the target relative to the aircraft based on the visual frame (referred to as the second orientation herein), reference may be made to the relevant description in the process of 102, which is not repeated here.

At 306, a second coordinate of the target in the navigation coordinate system is determined based on the second distance and the second orientation.

In applications, the specific implementation of determining the coordinate of the target in the navigation coordinate system (referred to as the second coordinate herein) based on the second distance and the second orientation is similar to the specific implementation of determining the first coordinate of the target in the navigation coordinate system based on the first distance and the first orientation, which is not repeated here.

In some embodiments, there is no inevitable temporal sequence between processes of 301 to 303 and processes of 304 to 306, that is, processes of 301 to 303 can be performed first, and then processes of 304 to 306 can be performed, or processes of 304 to 306 can be performed first, and then processes of 301 to 303 can be performed, or the two groups of processes can be performed simultaneously.

At 307, after switching from the near-field state to a far-field state, and/or in the near-field state and the far-field state, the flight of the aircraft is controlled based on the first coordinate and/or the second coordinate, and the coordinate of the aircraft in the navigation coordinate system.

In some embodiments, when the proportion of the size of a visual frame of the target in a shot image is less than a preset first ratio threshold, and/or a distance between the target and the aircraft is greater than a preset first distance, it is determined to be in the far-field state.

In applications, after switching from the near-field state to the far-field state, the flight of the aircraft may be controlled based on the first coordinate and/or the second coordinate, and the coordinate of the aircraft in the navigation coordinate system.

In the near-field state and the far-field state, the flight of the aircraft may be controlled based on the first coordinate and/or the second coordinate, and the coordinate of the aircraft in the navigation coordinate system.

For controlling the flight of the aircraft based on the first coordinate and the coordinate of the aircraft in the navigation coordinate system, or controlling the flight of the aircraft based on the second coordinate and the coordinate of the aircraft in the navigation coordinate system, reference can be made to the relevant description in the above embodiments of the present disclosure and the description is not repeated here.

In some embodiments, controlling the flight of the aircraft based on the first coordinate and the second coordinate, and the coordinate of the aircraft in the navigation coordinate system may include fusing the first coordinate and the second coordinate through a filter and controlling the flight of the aircraft based on the fused coordinate and the coordinate of the aircraft in the navigation coordinate system.

Specifically, considering that the coordinate of the target determined by the method of the depth map or the method of the visual frame always have some deviation from the real coordinate of the target, that is, there is noise, in order to improve the accuracy of the target coordinate, after the first coordinate and the second coordinate are obtained, the first coordinate and the second coordinate can be fused through a filter, and the flight of the aircraft can be controlled based on the fused coordinate and the coordinate of the aircraft in the navigation coordinate system.

In one example, the above filter may be a Kalman filter.

Correspondingly, fusing the first coordinate and the second coordinate through the filter may include in the aircraft-follow-target mode, obtaining the type of the target and determining a state equation of the Kalman filter based on the type of target, and fusing the first coordinate and the second coordinate based on the Kalman filter with the determined state equation.

Specifically, when the Kalman filter is used for noise filtering, the state equations of the Kalman filters corresponding to different target types are also different. Therefore, when the Kalman filter is used for noise filtering, the type of target needs to be determined first, and the state equation of the Kalman filter corresponding to the type of target is determined.

For example, if the target type is a car, a bicycle model can be used, and if the target type is a pedestrian, a uniform acceleration motion model can be used.

Correspondingly, in the aircraft-follow-target mode, before using the Kalman filter for coordinate fusion, the type of target can be obtained first, and the state equation of the Kalman filter is determined based on the type of target. Further, the first coordinate and the second coordinate are fused based on the Kalman filter with the determined state equation.

For example, assume that the type of target is a pedestrian, a uniform acceleration motion model can be used.

$$\{ \begin{matrix}x ( n ) = Ax ( n - 1 ) + Bu ( n ) + w ( n ) & ( 1 ) \\ z ( n ) = H ( n ) x ( n ) + v ( n ) & ( 2 )\end{matrix}$$

where x(n) is a system state vector, u(n) is a driving input vector, w(n) is the estimated noise, A and B are constant coefficient matrices, that is, the state equations in the state space. z(n) is an observation result (that is, a measurement result), H(n) is an observation vector, and v(n) is the observation noise.

The state equation is as follows:

\hat{x}(n|n−1)=A\hat{x}(n−1|n−1)+Bu(n) (3)

where x(n−1|n−1) is the optimal mean of the estimated error at time n−1, x(n|n−1) is the mean of the estimated error at time n, and x(n|n) is the optimal mean of the estimated error at time n.

The minimum mean square error matrix is as follows:

P(n|n−1)=AP(n−1|n−1)A^{T}+Q (4)

where P(n−1|n−1) is the optimal estimate of the square error matrix at time n−1, P(n|n−1) is the estimated value of the square error matrix at time n, and P(n|n) is the optimal estimate of the square error matrix at time n.

The Kalman gain coefficient equation is as follows:

$$K ( n ) = \frac{P ( n \vert n - 1 ) {H}^{T} ( n )}{R ( n ) + H ( n ) P ( n \vert n - 1 ) {H}^{T} ( n )} \qquad ( 5 )$$

where P(n|n−1)H^{T}(n) is the estimated minimum mean square error at time n, R(n) is the measurement error at time n, R(n)+H(n)P(n|n−1)H^{T}(n) is the total error at time n.

In the embodiments of the present disclosure, when only the first coordinate and the coordinate of the aircraft in the navigation coordinate system are used to control the flight of the aircraft, or only the second coordinate and the coordinate of the aircraft in the navigation coordinate system are used to control the flight of the aircraft, a filter (such as a Kalman filter) can still be used to filter the first coordinate and the second coordinate to improve the accuracy of the coordinate of the target in the navigation coordinate system and improve the accuracy of the flight control of the aircraft.

It should be recognized that the above filter is not limited to the Kalman filter, for example, the filter may also be a Butterworth filter, the specific implementation of which is not repeated here.

In addition, in the embodiments of the present disclosure, when the target is provided with a GPS device or an Ultra-Wideband (UWB) positioning device, the coordinate of the target in the navigation coordinate system may be directly determined by the GPS device or the UWB device. In some other embodiments, when the aircraft is provided with a lidar, the coordinate of the target in the navigation coordinate system can also be obtained through the lidar device, and the specific implementation thereof is not described here.

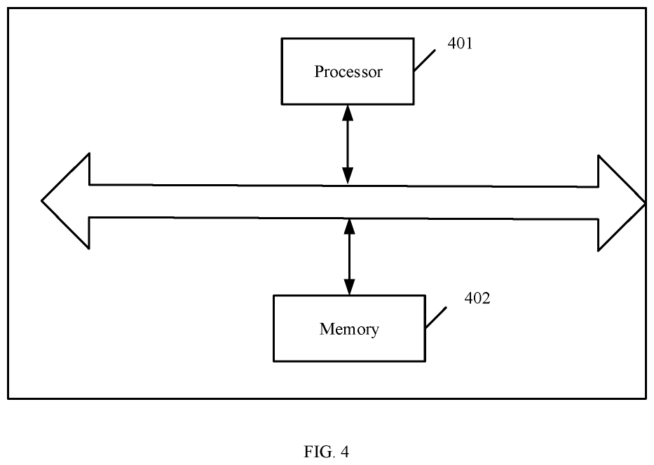

As shown in FIG. 4, a structural diagram of a flight control device is provided according to an embodiment of the present disclosure. The device is configured to perform a method consistent with the disclosure, such as one of the above-described example embodiments, e.g., the example method shown in and described in connection with FIG. 1. As shown in FIG. 4, the device includes a processor 401 and a memory 402.

The processor 401 is configured to determine a first distance of the target relative to the aircraft based on a depth map acquired by the first imaging device. The processor 401 is further configured to determine a first orientation of the target relative to the aircraft. The memory 402 is configured to store the first distance and the first orientation. The processor 401 is further configured to control the flight of the aircraft based on the first distance and the first orientation.

In one embodiment, the processor 401 is specifically configured to determine the target in the depth map and determine the first distance of the target relative to the aircraft based on the depth map.

In one embodiment, the processor 401 is specifically configured to cluster each pixel of the depth map, identify a target based on the shape and/or size of the point clouds obtained from clustering, determine the position of the target in the depth map, and determine the first orientation of the target relative to the aircraft based on the position of the target in the depth map.

In one embodiment, the aircraft is further provided with a second imaging device. Correspondingly, the processor 401 is specifically configured to determine a visual frame in which the target is framed in the shot image from the second imaging device, rotationally map the visual frame in the shot image to the depth map, and then determine the position of the target in the depth map based on the visual frame mapped to the depth map.

In one embodiment, the aircraft is further provided with a second imaging device. Correspondingly, the processor 401 is specifically configured to determine a visual frame in which the target is framed in the shot image from the second imaging device, and determine the first orientation of the target relative to the aircraft based on the position of the visual frame in the shot image.

In one embodiment, the processor 401 is specifically configured to determine the target in a grayscale image acquired by the first imaging device, where the depth map is determined based on the grayscale image, and determine the first orientation of the target relative to the aircraft based on the position of the target in the grayscale image.

In one embodiment, the aircraft is further provided with a second imaging device. Correspondingly, the processor 401 is specifically configured to determine a visual frame in which the target is framed in the shot image from the second imaging device, rotationally map the visual frame in the shot image to the grayscale image, and then determine the target in the grayscale image based on the visual frame mapped to the grayscale image.

In another embodiments, the processor 401 is specifically configured to identify the target in the grayscale image using image recognition.

In one embodiment, the processor 401 is specifically configured to determine a first coordinate of the target in the navigation coordinate system based on the first distance and the first orientation, and control the flight of the aircraft based on the coordinate of the aircraft in the navigation coordinate system and the first coordinate. The memory 402 is configured to store the first coordinate.

In one embodiment, the processor 401 is specifically configured to cluster each pixel of the depth map, identify a target based on the shape and/or size of the point clouds obtained from clustering, determine the position of the target in the depth map, and determine the first orientation of the target relative to the aircraft based on the position of the target in the depth map.

In the present disclosure, the processor 401 determines the distance of the target relative to the aircraft based on the depth map obtained by the first imaging device, determines the orientation of the target relative to the aircraft, and further, controls the flight of the aircraft according to the distance and orientation of the target relative to the aircraft, therefore the flight control of the aircraft without the need for a remote control is realized, and the efficiency of flight control is improved. Determining the distance of the target relative to the aircraft through the depth map can increase the accuracy of the distance of the determined target relative to the aircraft, and therefore, the accuracy of the flight control of the aircraft can be improved.

In some embodiments, the processor 401 is specifically configured to, in a near-field state, and when the target is located in the field of view of the first imaging device, control the flight of the aircraft based on the first distance and the first orientation.

In one embodiment, the aircraft is further provided with a second imaging device. The processor 401 is further configured to, in a near-field state, when the target disappears from the field of view of the first imaging device, and when the target exists in the field of view of the second imaging device, determine a visual frame in which the target is framed in the shot image from the second imaging device, determine the current orientation of the target relative to the aircraft based on the visual frame, and update the first coordinate of the target in the navigation coordinate system according to the first coordinate of the target in the navigation coordinate determined last time and the current orientation.

In some embodiments, the aircraft is also provided with a second imaging device. Accordingly, the processor 401 is also configured to determine a visual frame in which the target is framed in the shot image from the second imaging device and determine a second distance and a second orientation of the target relative to the aircraft based on the visual frame. The processor 401 is further configured to determine the first coordinate of the target in the navigation coordinate system based on the first distance and the first orientation, and determine the second coordinate of the target in the navigation coordinate system based on the second distance and the second orientation. The memory 402 is also configured to store the second coordinate. The processor 401 is further configured to, after switching from the near-field state to a far-field state, and/or in the near-field state and the far-field state, control the flight of the aircraft based on the first coordinate and/or the second coordinate, and the coordinate of the aircraft in the navigation coordinate system.

In one embodiment, the processor 401 is specifically configured to fuse the first coordinate and the second coordinate through a filter and control the flight of the aircraft based on the fused coordinate and the coordinate of the aircraft in the navigation coordinate system. The memory 402 is also configured to store the fused coordinate.

In one embodiment, the filter is a Kalman filter. Correspondingly, the processor 401 is also configured to acquire the type of the target in the aircraft-follow-target mode, determine the state equation of the Kalman filter based on the type of the target, and fuse the first coordinate and the second coordinate based on the Kalman filter with the determined state equation.

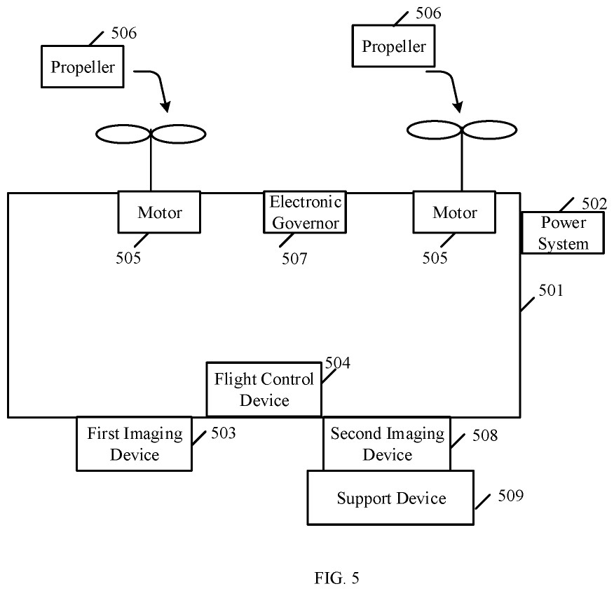

In the embodiments of the present disclosure, the flight control device shown in FIG. 4 may be mounted at an aircraft (such as a UAV). FIG. 5 shows an aircraft provided with a flight control device consistent with the disclosure. As shown in FIG. 5, the aircraft includes a body 501, a power system 502, a first imaging device 503, and a flight control device (labeled as 504) as described above.

The power system 502 is installed at the body to provide power for flight. The power system 502 includes at least one of a motor 505, a propeller 506, and an electronic governor 507.

The specific principles and implementation of the flight control device are similar to the above embodiments, and are not repeated here.

In addition, as shown in FIG. 5, the aircraft further includes a second imaging device 508 and a support device 509. The support device 509 may specifically be a gimbal, and the second imaging device 508 is fixedly connected to the aircraft through the support device 509.

A machine-readable storage medium is provided according to an embodiment. The machine-readable storage medium stores a number of computer instructions, and the computer instructions are executed to determine a first distance of the target relative to the aircraft based on the depth map obtained by a first imaging device, determine a first orientation of the target relative to the aircraft, and control the flight of the aircraft based on the first distance and the first orientation.

In one embodiment, the computer instructions are executed to determine a target in the depth map, and determine the first distance of the target relative to the aircraft based on the depth map.

In one embodiment, the computer instructions are executed to cluster each pixel in the depth map, identify the target based on the shape and/or size of the point cloud obtained by the clustering, determine the position of the target in the depth map, and determine the first orientation of the target relative to the aircraft based on the position of the target in the depth map.

In one embodiment, the computer instructions are executed to determine a visual frame in which the target is framed in the shot image from the second imaging device, rotationally map the visual frame in the shot image to the depth map, and determine the position of the target in the depth map based on the visual frame mapped to the depth map.

In one embodiment, the computer instructions are executed to determine a visual frame in which the target is framed in the shot image from the second imaging device, and determine the first orientation of the target relative to the aircraft based on the position of the visual frame in the shot image.

In one embodiment, the computer instructions are executed to determine the target in a grayscale image obtained by the first imaging device, and determine the first orientation of the target relative to the aircraft based on the position of the target in the grayscale image. The depth map is determined based on the grayscale image.

In one embodiment, the computer instructions are executed to determine a visual frame in which the target is framed in the shot image from the second imaging device, rotationally map the visual frame in the shot image to the grayscale image, and determine the target in the grayscale image based on the visual frame mapped to the grayscale image.

In one embodiment, the computer instructions are executed to identify the target in the grayscale image using image recognition.

In one embodiment, the computer instructions are executed to determine the first coordinate of the target in the navigation coordinate system based on the first distance and the first orientation, and control the flight of the aircraft based on the coordinate of the aircraft in the navigation coordinate system and the first coordinate.

In one embodiment, the computer instructions are executed to, in the aircraft-follow-target mode, control the following of the aircraft to the target based on the first distance and the first orientation, and/or, in a mode of controlling the aircraft based on the gesture of the target, control the aircraft in response to the gesture control instruction of the target based on the first distance and the first orientation.

In one embodiment, the computer instructions are executed to, in a near-field state and when the target is located in the field of view of the first imaging device, control the flight of the aircraft based on the first distance and the first orientation.

In one embodiment, the computer instructions are executed to, in a near-field state and when the target disappears from the field of view of the first imaging device, determine the current orientation of the target relative to the aircraft based on the visual frame, and update the first coordinate of the target in the navigation coordinate system according to the first coordinate of the target in the navigation coordinate determined last time and the current orientation.

In one embodiment, the computer instructions are executed to determine a visual frame in which the target is framed in the shot image from the second imaging device, determine a second distance and a second orientation of the target relative to the aircraft based on the visual frame, determine the first coordinate of the target in the navigation coordinate system based on the first distance and the first orientation, determine the second coordinate of the target in the navigation coordinate system based on the second distance and the second orientation, and after switching from the near-field state to a far-field state and/or in the near-field state and the far-field state, control the flight of the aircraft based on the first coordinate and/or the second coordinate, and the coordinate of the aircraft in the navigation coordinate system.

In one embodiment, the computer instructions are executed to fuse the first coordinate and the second coordinate through a filter, and control the flight of the aircraft based on the fused coordinate and the coordinate of the aircraft in the navigation coordinate system.

In one embodiment, the computer instructions are executed to in the aircraft-follow-target mode, obtain the type of the target and determine the state equation of the Kalman filter based on the type of the target, and fuse the first coordinate and the second coordinate based on the Kalman filter with the determined state equation.

Since the device embodiments basically correspond to the method embodiments, the relevant part may refer to the description of the method embodiment. The device embodiments described above are only schematic. The units described as separate components may or may not be physically separated, and the components shown as units may or may not be physical units, that is, they may be located at one place, or may be distributed across multiple network units. Some or all of the modules may be selected according to actual needs to achieve the objective of the embodiment. Those of ordinary skill in the art can understand and implement the embodiments without creative efforts.

In the present disclosure, relational terms such as first and second are only used to distinguish one entity or operation from another entity or operation, and do not necessarily require or imply that there is any such actual relationship or order between these entities or operations. The term “comprising,” “including” or any other variation thereof is non-exclusive inclusion, such that a process, method, article, or device that include a series of elements include not only those elements but also other elements that are not explicitly listed, or elements that are inherent to such a process, method, article, or device. Without more restrictions, the elements defined by the sentence “including a . . . ” do not exclude the existence of other identical elements in the process, method, article, or equipment that includes the elements.

The methods and devices provided by the present disclosure are described in detail above. Specific examples are used to explain the principles and implementation of the present disclosure. The descriptions of the above embodiments are only for facilitating the understanding of the present disclosure; meanwhile, for a person of ordinary skill in the art, according to the present disclosure, there will be changes in the specific implementation and application. In summary, the content of this specification is not a limitation to this disclosure.

What is claimed is:

1. A flight control method comprising:
determining a distance of a target relative to an aircraft based on a depth map acquired by an imaging device carried by the aircraft;
determining an orientation of the target relative to the aircraft; and
controlling flight of the aircraft based on the distance and the orientation.

2. The method of claim 1, wherein determining the distance of the target relative to the aircraft includes:
determining the target in the depth map; and
determining the distance of the target relative to the aircraft based on the depth map.

3. The method of claim 1, wherein determining the orientation of the target relative to the aircraft includes:
clustering pixels of the depth map to obtain a point cloud;
identifying the target based on at least one of a shape or a size of the point cloud;
determining a position of the target in the depth map; and
determining the orientation of the target relative to the aircraft based on the position of the target in the depth map.

4. The method of claim 3, wherein:
the imaging device is a first imaging device;
the aircraft further includes a second imaging device; and
determining the position of the target in the depth map includes:
determining a visual frame that frames the target in a shot image from the second imaging device;
rotationally mapping the visual frame in the shot image to the depth map; and
determining the position of the target in the depth map based on the visual frame mapped to the depth map.

5. The method of claim 1, wherein:
the imaging device is a first imaging device;
the aircraft further includes a second imaging device; and
determining the orientation of the target relative to the aircraft includes:
determining a visual frame that frames the target in a shot image from the second imaging device; and
determining the orientation of the target relative to the aircraft based on a position of the visual frame in the shot image.

6. The method of claim 1, wherein determining the orientation of the target relative to the aircraft includes:
determining the target in a grayscale image acquired by the imaging device, the depth map being determined based on the grayscale image; and
determining the orientation of the target relative to the aircraft based on a position of the target in the grayscale image.

7. The method of claim 6, wherein:
the imaging device is a first imaging device;
the aircraft further includes a second imaging device; and
determining the target in the grayscale image includes:
determining a visual frame that frames the target in a shot image from the second imaging device;
rotationally mapping the visual frame in the shot image to the grayscale image; and
determining the target in the grayscale image based on the visual frame mapped to the grayscale image.

8. The method of claim 6, wherein determining the target in the grayscale image includes identifying the target in the grayscale image using image recognition.

9. The method of claim 1, wherein controlling the flight of the aircraft includes:
determining a coordinate of the target in a navigation coordinate system based on the distance and the orientation; and
controlling the flight of the aircraft based on a coordinate of the aircraft in the navigation coordinate system and the coordinate of the target in the navigation coordinate system.

10. The method of claim 1, wherein controlling the flight of the aircraft includes at least one of:
in an aircraft-follow-target mode, controlling the aircraft to follow the target based on the distance and the orientation; or
in a mode of controlling the aircraft based on a gesture of the target, controlling the aircraft in response to a control instruction associated with the gesture of the target based on the distance and the orientation.

11. The method of claim 1, wherein controlling the flight of the aircraft includes, in a near-field state and when the target is located in a field of view of the imaging device, controlling the flight of the aircraft based on the distance and the orientation.

12. The method of claim 11,
wherein the imaging device is a first imaging device and the aircraft further includes a second imaging device;
the method further comprising:
in a near-field state, in response to the target disappearing from a field of view of the first imaging device but remaining in a field of view of the second imaging device, determining a visual frame that frames the target in a shot image from the second imaging device;
determining a current orientation of the target relative to the aircraft based on the visual frame; and
updating a coordinate of the target in a navigation coordinate system according to the current orientation and a coordinate of the target in the navigation coordinate determined last time.

13. The method of claim 11,
wherein:
the imaging device is a first imaging device and the aircraft further includes a second imaging device; and
the distance is a first distance and the orientation is a first orientation;
the method further comprising:
determining a visual frame that frames the target in a shot image from the second imaging device;
determining a second distance and a second orientation of the target relative to the aircraft based on the visual frame;
determining a first coordinate of the target in a navigation coordinate system based on the first distance and the first orientation;
determining a second coordinate of the target in the navigation coordinate system based on the second distance and the second orientation; and
controlling the flight of the aircraft based on a coordinate of the aircraft in the navigation coordinate system and at least one of the first coordinate or the second coordinate.

14. The method of claim 13, wherein controlling the flight of the aircraft based on a coordinate of the aircraft in the navigation coordinate system and at least one of the first coordinate or the second coordinate includes:
fusing the first coordinate and the second coordinate through a filter to obtain a fused coordinate; and
controlling the flight of the aircraft based on the fused coordinate and the coordinate of the aircraft in the navigation coordinate system.

15. The method of claim 14, wherein the filter includes a Kalman filter and fusing the first coordinate and the second coordinate through the filter includes:
in an aircraft-follow-target mode, obtaining a type of the target and determining a state equation of the Kalman filter based on the type of the target; and
fusing the first coordinate and the second coordinate based on the Kalman filter with the state equation.

16. A flight control device comprising:
a processor configured to:
determine a distance of a target relative to an aircraft based on a depth map acquired by an imaging device carried by the aircraft;
determine an orientation of the target relative to the aircraft; and
control flight of the aircraft based on the distance and the orientation; and
a memory configured to store the distance and the orientation.

17. The flight control device of claim 16, wherein the processor is further configured to:
determine the target in the depth map; and
determine the distance of the target relative to the aircraft based on the depth map.

18. The flight control device of claim 16, wherein the processor is further configured to:
cluster pixels of the depth map to obtain a point cloud;
identify the target based on at least one of a shape or a size of the point cloud;
determine a position of the target in the depth map; and
determine the orientation of the target relative to the aircraft based on the position of the target in the depth map.

19. The flight control device of claim 18, wherein:
the imaging device is a first imaging device;
the aircraft further includes a second imaging device; and
the processor is further configured to:
determine a visual frame that frames the target in a shot image from the second imaging device;
rotationally map the visual frame in the shot image to the depth map; and
determine the position of the target in the depth map based on the visual frame mapped to the depth map.

20. The flight control device of claim 16, wherein:
the imaging device is a first imaging device;
the aircraft further includes a second imaging device; and
the processor is further configured to:
determine a visual frame that frames the target in a shot image from the second imaging device; and
determine the orientation of the target relative to the aircraft based on a position of the visual frame in the shot image.
